(19) United States
(12) Patent Application Publication
(10) Pub. No.: US 2015/0289460 A1
(43) Pub. Date: Oct. 15, 2015

(54) Automated Plant Irrigation Method and System using Weight and Leak Sensors

(71) Applicant: Jules Sanford Vanderveken, Lake Winola, PA (US)

(72) Inventor: Jules Sanford Vanderveken, Lake Winola, PA (US)

(21) Appl. No.: 14/249,510

(22) Filed: Apr. 10, 2014

(51) Int. Cl. A01G 27/00; A01G 1/00

(52) U.S. Cl. CPC A01G 27/003; A01G 1/001

(57) ABSTRACT

Embodiments of the disclosed technology are directed to methods, systems, and/or apparatuses for monitoring and maintaining hydration levels in plants. The technology employs a base onto which a plant is placed. The base may have a built-in scale, as well as a spout for dispensing water. The spout may be coupled to a water supply via a pump. The scale may be coupled to a processor used to weigh the plant, detect fluctuations in weight, and/or to initiate/cease dispensing of water to the plant based on detected parameters. A leak sensor may also be incorporated into the spout for cutting off the water supply upon detection of possible over-watering. The base may also have an input for facilitating user control over the irrigation frequency and dosage.

### FIELD OF THE DISCLOSED TECHNOLOGY

The disclosed technology relates generally to irrigation systems, and more particularly to automated or semi-automated watering systems for plants.

### BACKGROUND OF THE DISCLOSED TECHNOLOGY

Maintenance of plants, crops and other vegetation can be difficult, given the fragility of different species. Often over-watering or under-watering causes plants to perish. This may prove to be very frustrating and costly to those desiring to properly cultivate plants.

Many systems and devices exist, both on a domestic and an industrial level, for properly watering plants. Moreover, large scale irrigation systems are used in farms, vineyards, and greenhouses to effectively water large areas of plants. However, many of these systems do not monitor each and every plant individually. They typically irrigate each plant in a large group of plants with an approximate dosage of water. Inevitably, different plants, having different sizes and weights, will be over-watered or under-watered. Even within a given species, variability among plants results in different water needs for sustainability.

While some systems and devices exist for monitoring plants individually, these systems and devices are often complex and expensive, require a great number of sensors and other items. Thus, needed in the art are more effective systems and methods for monitoring moisture levels and/or watering individual plants based on easily measurable factors.

### SUMMARY OF THE DISCLOSED TECHNOLOGY

Therefore, it is an object of the disclosed technology to find an efficient and automated way to monitor and water plants based on weight and/or over-watering sensors.

In an embodiment of the disclosed technology, a system is used for watering a plant. The system has a base adapted for receiving the plant. The base has a scale engaged with a surface thereof. The scale may use a strain gauge or other electronic mechanism for measuring the weight of the plant. The system further employs a spout coupled to a water supply for directing water into the plant. A control is also provided for manually controlling the flow of the water.

A liquid capacitance sensor is disposed on the top surface of the base. The sensor is used to detect liquid that might cause the water supply to be cut off. The presence of liquid at the leak sensor is indicative of over-watering or a leak due to the leak sensor residing outside of the confines of the plant. The liquid capacitance sensor may further employ a vessel adapted to collect water, and an electric cut-off circuit. The electric circuit has two capacitance plates disposed on an interior surface of the vessel, such that the presence of water in the vessel submerges the plates and causes activation of the circuit.

In a further embodiment of the disclosed system, the scale is operable to continuously measure the weight of the plant and to cause water to be directed into the plant upon a detected reduction in the weight of the plant. Still further, the scale may be configured to trigger watering through the spout upon the weight of the plant dropping below a predefined threshold.

In another embodiment of the disclosed technology, a method is used for watering a plant. The method is carried out, not necessarily in the following order, by: a) receiving a sufficiently watered plant on a base, the base having an electronic scale incorporated therein; b) measuring and storing an initial weight of the sufficiently watered plant; c) detecting a reduction of weight of the plant; d) dispensing water onto the plant; and/or e) stopping the dispensing of water upon detecting that the plant has reached the initial weight. A “sufficiently watered plant,” for purposes of this disclosure, may be defined as any plant that has been hydrated to the point at which the soil in which the plant is planted is sufficiently moist. The amount of water required to “sufficiently water the plant” may depend on a number of factors, including plant species, plant weight, soil volume, climate, plant health, etc. For example, a cactus would need substantially less water than a palm tree; thus the definition of “sufficiently watered” would vary accordingly.

A non-transitory computer-readable storage medium may have artificial intelligence instructions for carrying out one or more of the aforementioned steps using a processor. A “non-transitory computer readable storage medium” is, for purposes of this specification, any form of computer-readable media that has the ability to electrically, magnetically, and/or mechanically dent or otherwise change the physical shape or chemical properties of a physical device, in order to store data for a period of time of at least 1 hour or a length of time which may later be decided by a court of law to be considered “non-transitory.” Such may include register memory, processor cache, and Random Access Memory (RAM). Such a “computer readable storage medium” may include forms of non-tangible media and transitory propagation of signals.

In further embodiments of the disclosed method, an additional step may be provided of detecting an overflow of water during the dispensing. Upon detection of an overflow, the dispensing of water is stopped to prevent further over-watering. The overflow may be detected by a liquid capacitance sensor. In still further embodiments of the disclosed method, the detectable reduction in weight exceeds a measurable threshold. As such, a small/negligible decrease in weight would not cause dispensing of water. Thus, a sufficient reduction in weight, such as, for example, a 5% reduction in weight or a 3 pound loss, would be required to initiate watering. This threshold may be pre-defined by a user via an input associated with the base.

In still another embodiment of the disclosed technology, a method is used for watering a plant. The method is carried out, not necessarily in the following order, by: a) receiving a plant on a base, where the base has a spout and a scale; b) directing an amount of water into the plant, where the amount of water is equal in weight to 25% of the initial weight of the plant; c) re-measuring a new weight of the plant; d) comparing the new weight to 125% of the initial weight; and/or e) dosing water to the plant until the new weight is greater than or equal to 125% of the initial weight.

In a further embodiment of the disclosed method, an additional step may be provided of detecting if the plant has been over-watered, using a leak sensor. Furthermore, the water may be dosed in increments between 1% and 5% of the initial weight of the plant.

It should be understood that the use of “and/or” is defined inclusively such that the term “a and/or b” should be read to include the sets: “a and b,” “a or b,” “a,” “b.” Further details are set forth in the detailed description below.

### BRIEF DESCRIPTION OF THE DRAWINGS

FIG. 1 shows an elevation view of a plant irrigation system in an embodiment of the disclosed technology.

FIG. 2 shows a diagram of a water-activated, capacitance shut-off switch used in an embodiment of the disclosed technology.

FIG. 3 shows the capacitance shut-off switch of FIG. 2 with liquid disposed therein.

FIG. 4 shows a flow chart of steps taken in a method used in embodiments of the disclosed technology.

FIG. 5 shows a flow chart of steps taken in another method used in embodiments of the disclosed technology.

FIG. 6 shows a high-level block diagram of a device of the base that may be used to carry out the disclosed technology.

### DETAILED DESCRIPTION OF EMBODIMENTS OF THE DISCLOSED TECHNOLOGY

Embodiments of the disclosed technology are directed to methods, systems, and/or apparatuses for monitoring and maintaining hydration levels in plants. The technology employs a base or platform onto which a plant is placed. The plant may be potted in a container or vessel. The base may have a built-in scale as well as a spout for dispensing water. The spout may be coupled to a water supply via a pump. The scale may be coupled to a processor used to weigh the plant, detect fluctuations in weight, and/or to initiate/cease dispensing of water to the plant based on detected parameters. A leak sensor may also be incorporated into the spout for cutting off the water supply upon detection of possible over-watering. The base may also have an input for facilitating user control over the irrigation frequency and dosage.

Embodiments of the disclosed technology will become clearer in view of the following description of the figures.

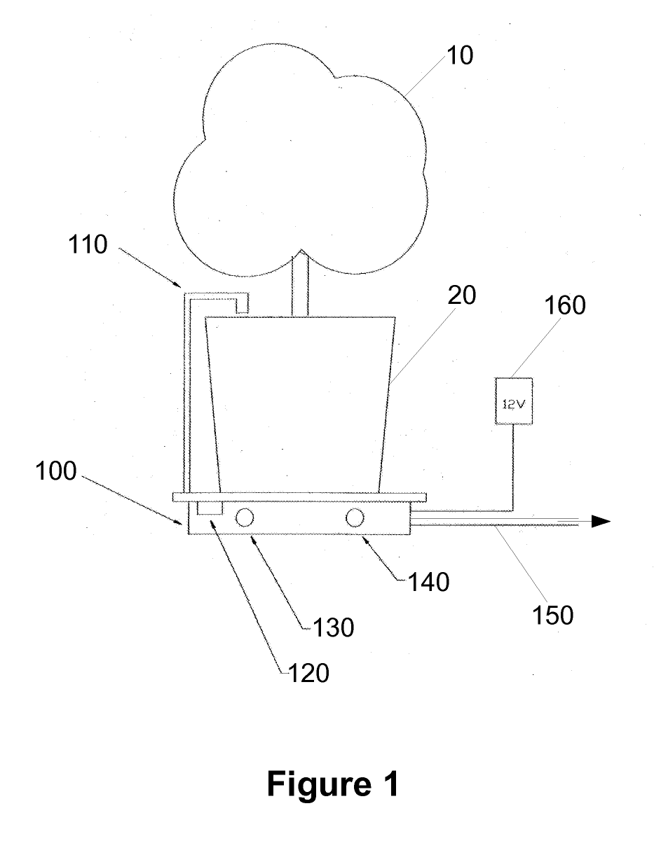

FIG. 1 shows an elevation view of a plant irrigation system in an embodiment of the disclosed technology. A plant 10 is shown within a pot 20. The pot 20 rests atop a base 100, the base having a built-in scale (not shown) associated therewith. The scale measures the weight of the plant 10. The weight of the plant 10 may be measured continuously, or over increments of time, T.

A spout 110 extends from a portion of the base 100. The spout 110 is generally elongated, having an opening directed towards an interior of the pot 20. Water is directed through the spout 110 into the pot 20 for purposes of the watering the plant 10. The spout 110 is coupled to a water supply via an inflow pipe 150. The water supply may be a tank, a hose or any other water source. The water may be fed through the spout, using a pump (not shown) connected along the water supply line 150. The pump may be powered by electricity.

The spout 110 is calibrated to dispense water into the pot 20 based on the weight of the plant 10. Several different methods are disclosed for customized watering of the plant 10. In one embodiment, a fully watered/hydrated plant is placed onto the base 10. The determination that a plant 10 is fully hydrated may be based on a user's determination. The degree of ideal soil saturation will, of course, vary among different plant species. Upon initially placing the plant 10 atop the base 100, the weight of the plant is measured by the scale. This determined hydrated weight is stored in the base, preferably on computer-readable, non-transitory memory. Alternatively, an analog, non-electric embodiment may require a user to calibrate a dial 130 or 140 (or other device used to enact calibration) based on the initially determined weight.

Once the initial weight is determined, the weight of the plant continues to be measured, either perpetually or over a time duration, T. T may be any time duration between 30 seconds and 24 hours, and may be customized by the user, based on the plant species, the plant size, the climate, etc. After every iteration of checking the plant's weight, the current weight is compared to the initial, hydrated weight. Presumably, barring external factors such as rain, the plant 10 will be lighter than its original weight. In one embodiment, water is dispensed via the spout 110 until the plant 10 reaches its hydrated weight. The water may not be dispensed until the plant 10 has lost some threshold amount or percentage of weight, such as, for example, 3 pounds or 2% of the total weight.

In another embodiment, a user may input watering settings via control dials 130, 140 associated with the base. For example, the user may specify the weight in water or volume in water that the plant 10 should be watered on a daily basis, or over any other pre-specified duration.

A leak sensor 120 may be disposed in a top surface of the base 100. The leak sensor 120 is configured to cease the dispensing of water upon detection of water. The water may reach the leak sensor 120 by overflowing from the top or the base of the pot 20. The leak sensor 120 may be positioned such that any significant amount of water leaking onto the base 100 will be detectable. The leak sensor 120, base 100, and other components may be powered via a 12 volt source.

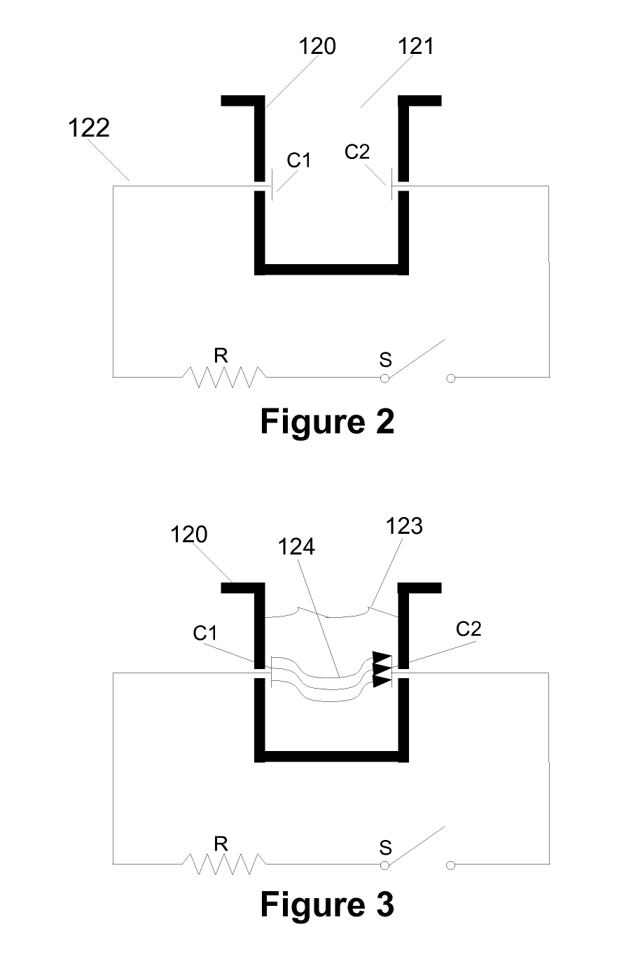

FIG. 2 shows a diagram of a water-activated, capacitance shut-off switch used in an embodiment of the disclosed technology. The circuit 122 of the shut-off switch may generally have a resistor R and switch S. The circuit 122 may further have two opposing conductive, capacitance plates C1 and C2. Each capacitance plate extends into an interior of the leak sensor cavity 121. The cavity 121 may be of any shape, volume, or cross-section. The cavity 121 is configured to receive and hold liquid (water) therein. Once enough water is collected into the cavity, the capacitance plates C1 and C2 will be immersed within the water, thereby activating the circuit 122. The size of the cavity 121 will, of course, dictate how much water is required to activate the capacitance switch.

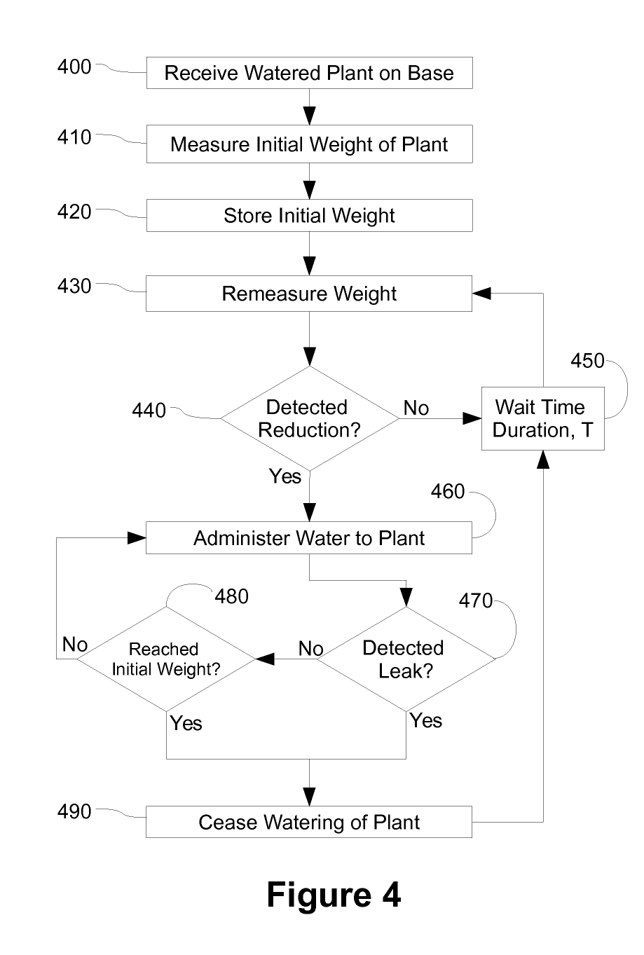

FIG. 3 shows the capacitance shut-off switch of FIG. 2 with liquid disposed therein. The surface 123 of the liquid is shown to be above the capacitance plates C1 and C2, thereby immersing them in the liquid. The high conductivity of the water enables the signal from C1 to be passed to C2, and vice-versa. As such, the circuit 122 is complete and therefore activated. Activation of the circuit causes the cessation of any water flow through the spout 110. Furthermore, activation of the leak sensor circuit may cut off the power to the whole base for purposes of safety in preventing shock or short-circuiting due the presence of water.

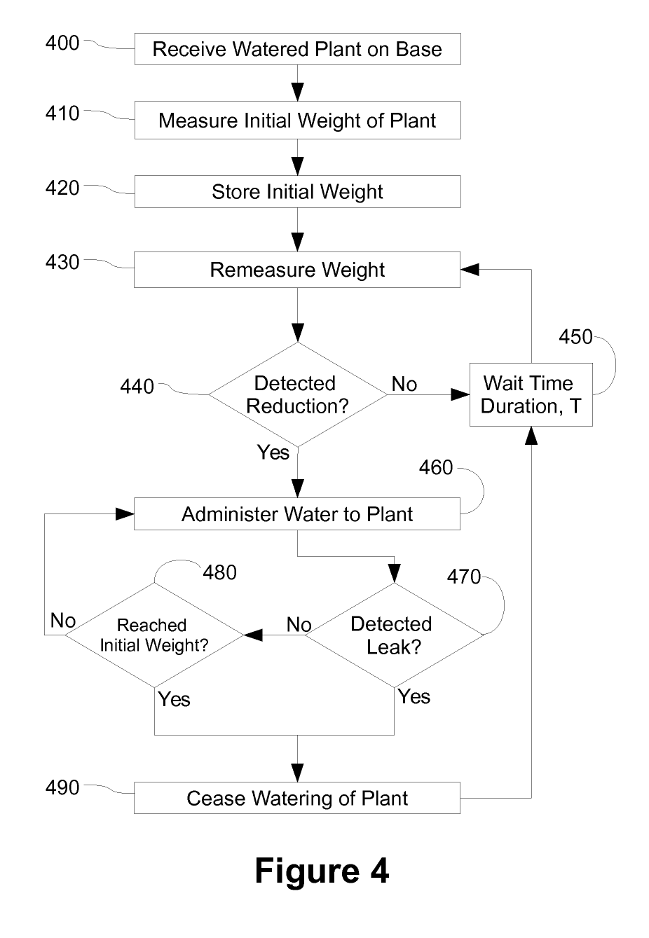

FIG. 4 shows a flow chart of steps taken in a method used in embodiments of the disclosed technology. The method begins in step 400 when a watered plant is received onto the base. The determination of hydration of the plant and its soil may be carried out by a user, a moisture sensor, or any other process. The method proceeds with step 410, whereby the initial/hydrated weight of the plant is measured. In step 420, the initial weight is recorded or otherwise stored by the base. Then, in step 430, the weight of the plant is re-measured. In step 440, the re-measured weight is compared to the initial weight to determine if a reduction of weight is detected. If no reduction in weight is detected, then the method proceeds to step 450, whereby a time duration, T, is waited until return back to step 430 for a re-measure of the plant's weight. If a weight reduction is detected, the method proceeds to step 460, whereby administration of water to the plant is initiated.

The next step, 470, determines, using the leak detector, whether a leak is detectable. If a leak is detected, the method proceeds directly to step 490, whereby the watering of the plant is ceased. If no leak is detected, the method proceeds to step 480, whereby a determination as to whether the plant has reached its initial weight is made. If the initial weight is not determined to have been met, the water is re-administered to the plant, or watering simply continues to be administered. Steps 460, 470 and 480 may be carried out contemporaneously; the processes of each step may be continuous.

Alternatively, the water may be administered in doses of a pre-specified volume, and thus the method may be carried out along the steps as shown. If, after the determination of step 480, the plant has reached its initial weight, the method proceeds to step 490. during which watering of the plant is stopped. After the watering of the plant is stopped, the method proceeds back to step 450, whereby a time duration begins running, after which the weight of the plant is re-measured (step 430). Thus, the iteration of measuring and watering continues perpetually, absent any intervening factors.

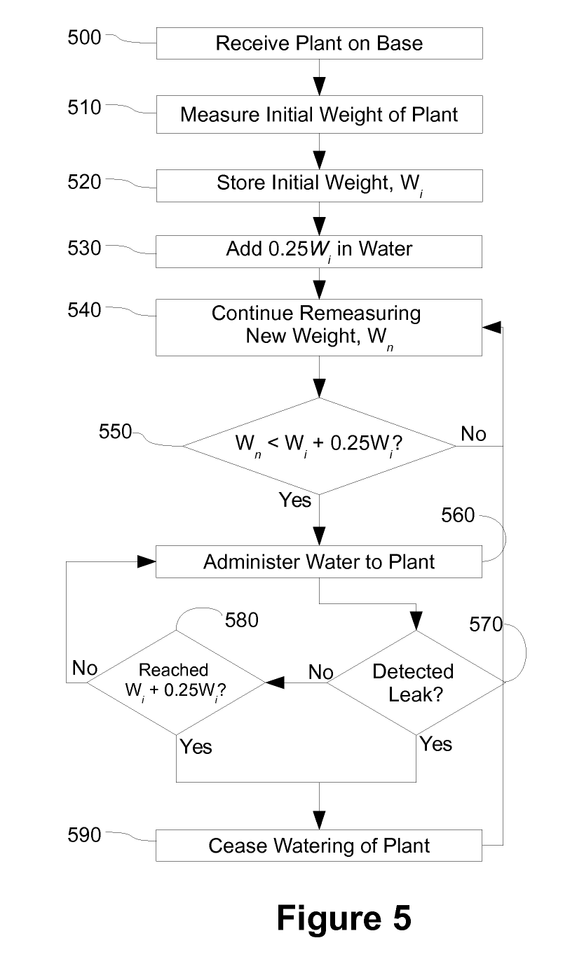

FIG. 5 shows a flow chart of steps taken in another method used in embodiments of the disclosed technology. First, the plant is placed on the base in step 500. In this embodiment, however, an initial weight of the plant is measured in step 510 before the plant is watered. In step 520, the initial weight, Wi, is stored. Next, in step 530, water is added to the plant. The weight of the water added should be approximately ¼th of the total weight of the plant. The base may assist a user in dosing the proper amount of water. For example, the base may automatically calculate ¼th the weight and may prompt the user to keep watering until that threshold has been reached.

Next, in step 540, the total new weight of the plant, Wₙ, is continuously re-measured. When re-measured in step 550, the new weight, Wₙ, is compared to the initial weight plus 25% to account for the water. If the new weight is more than the original weight, the method reverts to step 540. whereby the weight continues to be monitored and/or re-measured. If the new weight is less than the original weight with the water, then water is administered to the plant in step 560.

In step 570, the base checks for leaks. The status of the leak sensor may be continuously monitored throughout the other steps of the method. If no leak is detected, in step 580 it is determined whether the new weight, Wₙ, has reached the initial weight (Wⱼ+0.25 Wⱼ). If not, water continues to be administered to the plant (step 560). If the new weight has reached the initial weight, then in step 590 watering of the plant is ceased. After step 590, the method may continue in an iteration starting at step 540, whereby the weight of the plant is continuously re-measured.

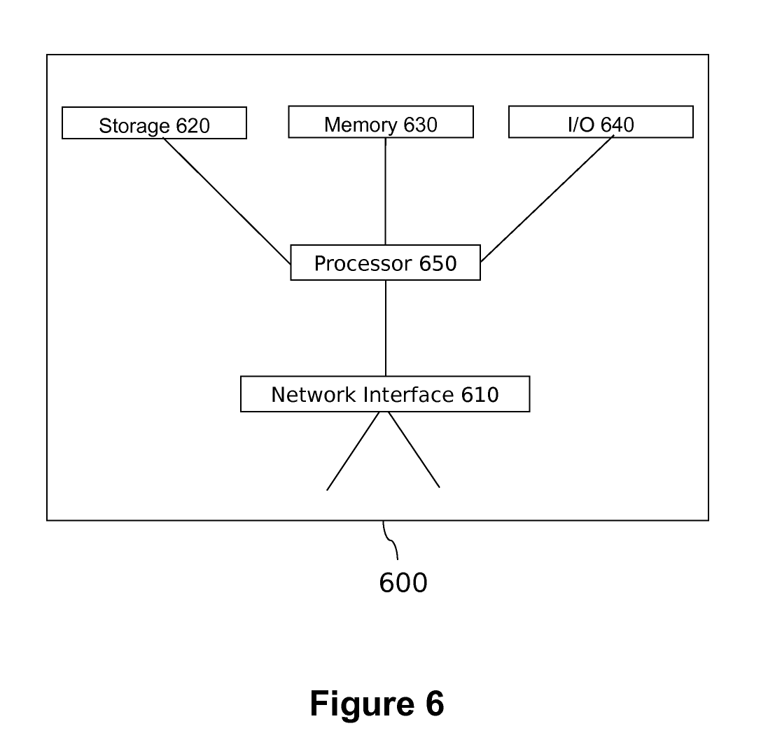

FIG. 6 shows a high-level block diagram of a device of the base that may be used to carry out the disclosed technology. Device 600 comprises a processor 650 that controls the overall operation of the computer by executing the device's program instructions which define such operation. The device's program instructions may be stored in a storage device 620 (e.g., magnetic disk, database) and loaded into memory 630 when execution of the console's program instructions is desired. Thus, the device's operation will be defined by the device's program instructions stored in memory 630 and/or storage 620, and the console will be controlled by processor 650 executing the console's program instructions.

A device 600 also includes one, or a plurality of, input network interfaces for communicating with other devices via a network (e.g., the internet). The device 600 further includes an electrical input interface for receiving power and data from a power source. A device 600 also includes one or more output network interfaces 610 for communicating with other devices. Device 600 also includes input/output 640, representing devices which allow for user interaction with a computer (e.g., dials, buttons, scale, display, keyboard, etc.). One skilled in the art will recognize that an implementation of an actual device will contain other components as well, and that FIG. 6 is a high level representation of some of the components of such a device for illustrative purposes. It should also be understood by one skilled in the art that the method and devices depicted in FIGS. 1 through 5 may be implemented on a device such as is shown in FIG. 6.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. A system for watering a plant, comprising:
a base adapted for receiving said plant, said base having a scale engaged with a surface thereof;
a spout coupled to a water supply for directing water into said plant;
a control for manually controlling said water; and
a liquid capacitance sensor disposed on said surface of said base;
wherein, upon said liquid capacitance sensor detecting liquid, said spout stops dispensing liquid from said water supply.

2. The system of claim 1, wherein said liquid capacitance sensor comprises:
a vessel adapted to collect water; and
an electric circuit having two capacitance plates disposed on an interior surface of said vessel, such that the presence of water in said vessel submerges said capacitance plates, thereby activating said circuit.

3. The system of claim 1, wherein said scale is operable to continuously measure a weight of said plant and to cause water to be directed into said plant upon a detected reduction in weight of said plant.

4. The system of claim 1, wherein said scale is configured to trigger watering through said spout upon a weight of said plant dropping below a predefined threshold.

5. A method of watering a plant comprising:
receiving a sufficiently watered plant on a base, said base having an electronic scale incorporated therein;
measuring and storing an initial weight of said sufficiently watered plant;
detecting a reduction of weight of said plant;
dispensing water onto said plant; and
ceasing said dispensing of water upon detecting that said plant has reached at least said initial weight.

6. The method of claim 5, further comprising:
detecting an overflow of water during said dispensing, and ceasing said dispensing in response thereto.

7. The method of claim 6, wherein said overflow is detected by a liquid capacitance sensor.

8. The method of claim 5, wherein said detectable reduction in weight exceeds a measurable threshold.

9. The method of claim 8, wherein threshold is pre-defined via an input associated with said base.

10. A method of watering a plant comprising:
receiving a plant on a base, said base having a spout and scale;
measuring an initial weight of said plant;
directing an amount of water into said plant, said amount of water being equal in weight to 25% of said initial weight of said plant;
re-measuring a new weight of said plant and comparing said new weight to 125% of said initial weight; and
dosing water to said plant until said new weight is greater than, or equal to, 125% of said initial weight.

11. The method of claim 10, further comprising:
detecting if said plant has been over-watered, using a leak sensor.

12. The method of claim 10, wherein said step of dosing water is carried out in increments of 5% of said initial weight.

13. The method of claim 10, wherein said step of dosing water is carried out in increments of 1% of said initial weight.
